(19) United States
(12) Patent Application Publication
(10) Pub. No.: US 2022/0366916 A1
(43) Pub. Date: Nov. 17, 2022

(54) ACCESS CONTROL SYSTEM

(71) Applicant: Itaú Unibanco S/A, São Paulo (BR)

(72) Inventors: Antonio Carlos dos Santos, São Paulo (BR); Guilherme Rinaldo, São Paulo (BR); João Victor Calvo Fracasso, São Paulo (BR); Roberth Ramos de Oliveira, São Paulo (BR); Victor Costa Beraldo, São Paulo (BR)

(73) Assignee: Itaú Unibanco S/A, São Paulo (BR)

(21) Appl. No.: 17/319,865

(22) Filed: May 13, 2021

(51) Int. Cl. G10L 17/22; G06F 21/32; G06N 3/08; G06N 3/04; G10L 17/04

(52) U.S. Cl. CPC G10L 17/22; G06F 21/32; G06N 3/08; G06N 3/04; G10L 17/04

(57) ABSTRACT

Method and system for granting access to a restricted area or allowing a user to access a restricted area. The method includes training of a machine learning engine, recording a voiceprint of a user, determining the voiceprint of a user to be validated when access is attempted; if a primary key is entered: select the voiceprint identified by the primary key, if no primary key is entered: identify the voiceprint closest to the recorded voiceprints and validating the voiceprint. The training of the machine learning engine may be carried out by capturing an audio sample through an audio capture device, wherein each user from a plurality of users repeats at least a same fixed phrase three times, wherein each audio sample of each user from a plurality of users is divided into two audio parts, training a machine learning engine by using the first part of the audio samples and validating the trained machine learning engine by using the second part of the audio samples. An anti-fraud method includes requesting the user to repeat a phrase, capturing the audio sample of the phrase repeated by the user, transcribing the phrase repeated by the user, and comparing the transcribed phrase with the targeted phrase

### FIELD

The present disclosure generally relates to a method of granting a user access to a restricted area of a service or an application, e.g., for an application in a call center.

### BACKGROUND

Voice biometrics technology has been widely studied for a wide range of applications. In some application approaches, voice biometrics is used for speech transcription or word recognition. Identification and authentication approaches are more focused on access control, forensic authentication, among other uses.

Nowadays, in the context of phone calls, the identity of a user is often verified using a verification protocol defined and implemented by an operator. This protocol typically consists of a series of personal information-related questions that are compared with a base of responses previously provided by the user. Some computer automated and/or machine learning approaches to identifying and authenticating users in a call center have been previously proposed. The present disclosure provides improved automated and machine learning approaches for identification and authentication of callers.

### SUMMARY

Some embodiments of the present disclosure provide a method for granting access to a restricted area, whose purpose is to detect, capture, and process audio data, particularly the voice of a user, in order to verify the identity of such user at the time they contact a call center or use a smartphone application, while not requiring the use of other security elements commonly used in user validation processes, such as keys or passwords.

Some embodiments of the present disclosure provide a method for granting access consisting of an arrangement of physical and virtual electronic devices capable of detecting, capturing and processing the voice of a user to verify their identity and grant access to a restricted area of a service or application.

Some embodiments of the present disclosure also provide a method for granting access which verifies or identifies a user based on the use of artificial intelligence, more specifically deep neural networks, to determine the voiceprint of a user, or the d-vector. The method was specifically designed for verification or identification and authentication applied to single-channel call center system, e.g., using 8,000-Hz audio samples.

Some methods for granting access described in the present disclosure may be of particular relevance because they are capable of processing poor quality audio samples, e.g., as seen in the Brazilian or other telephone systems, differently from countries with higher quality audio, where two channels are used for capturing the audio sample of phone calls and the sampling rate can reach up to 44,100 Hz.

Some embodiments of the present disclosure may provide a method for granting access that verifies or identifies a user in a call center by comparing the user's voice tag against the voiceprint previously registered and defined by the system.

Some embodiments of the present disclosure may also provide a method for training a machine learning engine to determine the voiceprint of the user as adapted to phonetic features of the Portuguese language, in particular the Portuguese spoken in Brazil, with its many phonological nuances and accents. It will be appreciated that the approach may be tailored for other languages and accents as well.

Some embodiments of the present disclosure may also provide an anti-fraud method to authenticate a user in order to prevent the inappropriate use of audio samples previously registered of a user.

Some embodiments of the present disclosure may also provide a method for adaptive normalization to improve the performance in different audio channels, such as calls through standard phone lines, cell phones, internet calls, etc.

Some embodiments of the present disclosure may also provide a system for granting access to a restricted area, configured to implement the stages of the method for granting access to a restricted area.

Some embodiments of the present disclosure may also provide a method for granting access to a restricted area so as to allow the access of a user to a restricted area, such method comprising: training a machine learning engine, wherein the machine learning engine is capable of generating a d-vector of a user from a captured audio sample; recording a d-vector of a user, wherein the pattern voiceprint of a user is associated with an primary key of the user; determining the voiceprint of a user to be validated when access is attempted, wherein a voiceprint is generated for the user attempting access, and if a primary key is entered, the pattern voiceprint identified by the primary key is selected, while if no primary key is entered, the voiceprint closest to the registered pattern voiceprints is identified; authenticating the user, wherein the user repeats a randomly selected phrase, and the phrase repeated by the user is transcribed for comparison against the targeted phrase; validating the voiceprint through a comparison between the voiceprint attempting access and the pattern voiceprint selected in the stage of determining the voiceprint to be validated.

Some embodiments of the present disclosure may also provide a method for training a machine learning engine, the said engine being applied to generate the voiceprint of a user, such method comprising: capturing an audio sample through an audio capture device, wherein audio samples of multiple people, e.g., at least 50 different people are captured; wherein the user repeats a same fixed phrase three times, wherein the audio sample is divided into parts, e.g., two audio parts, the first part comprising ⅔ of the audio length, and the second part comprising ⅓ of the audio length; training a machine learning engine using the first part of the captured audio samples; validating the trained machine learning engine using the second audio part; testing the trained engine using the audio sample of people other than those used in the machine learning engine training and validation; and storing the machine learning engine.

Some embodiments of the present disclosure may also provide a method for authenticating a user whenever such user attempts to access a restricted access area, the authentication method comprising: requesting the user to repeat a random phrase, which phrase is chosen when access is attempted; capturing the audio sample of a phrase repeated by the user; transcribing the phrase repeated by the user; comparing the transcribed phrase against the targeted phrase.

### BRIEF DESCRIPTION OF THE DRAWINGS

FIG. 1 shows a form of capturing audio samples according to an embodiment of the present disclosure;

FIG. 2 shows, schematically, an example of training and validation of the machine learning engine according to an embodiment of the present disclosure;

FIG. 3 shows an example of processing of the processing device generating voiceprints of users;

FIG. 4 shows an example of a system, according to an embodiment of the present disclosure, where one can observe the interaction between the input device, the processing device, and the storage device for the generation of a response;

FIG. 5 shows a voiceprint being obtained from the machine learning engine;

FIG. 6 shows a flowchart of an example procedure of the present disclosure;

FIG. 7 shows an example of the distance calculated for validating a voiceprint;

FIG. 8 shows an EER diagram of the SincNet model; and

FIG. 9 shows an EER diagram of the trained machine learning engine according to an embodiment of the present disclosure.

### DETAILED DESCRIPTION

One may notice that the prior art could benefit from a solution presenting a method for granting access to a restricted area, wherein the machine learning engine would be capable of being operated in certain conditions, such as, for example, a call center operating at a reduced bandwidth, e.g., 8,000 Hz, or a smartphone application, in addition to providing anti-fraud layers to prevent the inappropriate use of recorded voices, a training method that enables a high level of assertiveness under specific operating conditions, and a set of components and devices that allows one to operate these methods.

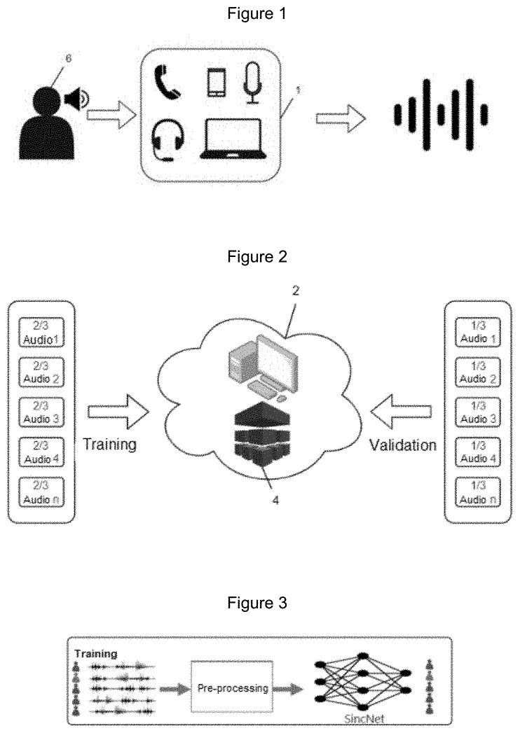

FIG. 1 shows a form of capturing the audio sample of a user through input devices (1). Such input devices (1) could be a sound recorder, a smartphone, a computer application, a call to a call center, or other input devices. The audio sample of the user's voice is converted into digital format for subsequent processing by the processing device.

FIG. 2 shows, schematically, an example of training and validation of the machine learning engine according to an embodiment of the present disclosure. In the exemplary embodiment, the audio sample of a number of different users is divided into two parts, the first part for training the machine learning engine and a second part of the audio sample for validating the trained machine learning engine.

FIG. 3 shows a form of execution in the processing device, wherein voiceprints are generated from the audio sample of each user. In the example of FIG. 3, the voiceprint is generated from the use of the structure presented by SincNet's machine learning engine.

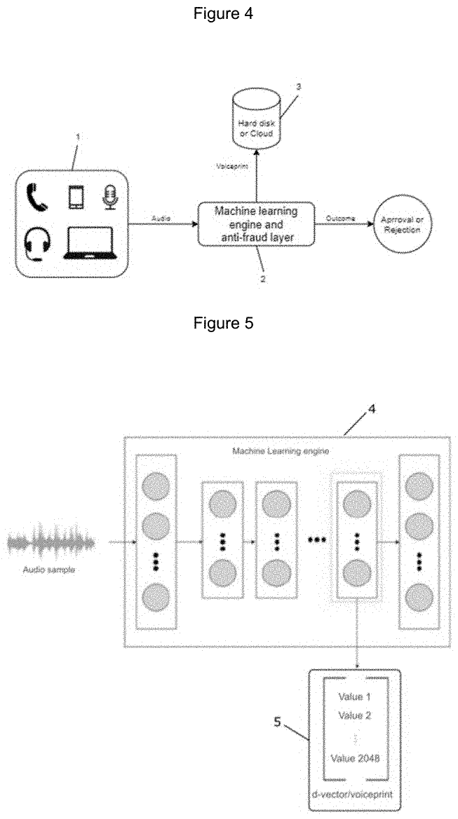

FIG. 4 shows an embodiment of the present disclosure with the machine learning engine and the anti-fraud layer being executed, so that a voiceprint and a rejection or an approval response are generated from an audio sample. The generated voiceprint can be a pattern voiceprint or a new voiceprint generated through an access attempt, for comparison with the pattern voiceprint registered previously.

FIG. 5 shows an example of voiceprint/d-vector generation, wherein an audio sample is processed by the many layers of the machine learning engine so that, in the last layer, a voiceprint is generated corresponding to the audio sample of a user's voice.

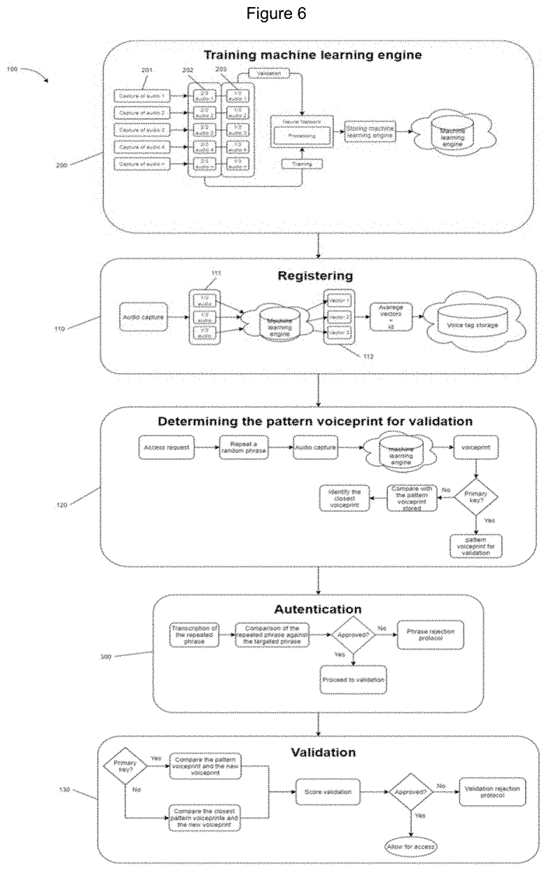

FIG. 6 shows an embodiment of the present disclosure with the method for granting access (100) comprising the stages of the method for training (200) of the machine learning engine (4), the stage of registering a user and their pattern voiceprint, the stage of determining a pattern voiceprint for validation, the authentication stage and the validation stage.

Still in FIG. 6, in the machine learning engine training stage, audio samples (201) are captured, wherein each of the audio samples (201) is divided into two parts, the first part (202) being used for training the machine learning engine, and a second part (203) being used for validating the trained machine learning engine. Once the validation is completed, the machine learning engine is stored for execution in a processing device.

Still in FIG. 6, the stage of registration (110) of users occurs so as to allow the registration of users attempting access in the future have their new voiceprint, obtained at the time access was attempted, compared with their previously registered pattern voiceprint. Registration occurs by capturing the audio sample (111) of a user through an input device (1), such audio sample preferably comprising the recording of the user's voice repeating a same phrase three times. Each phrase repetition by the user is then processed by the machine learning engine and each repetition generates a different d-vector/voiceprint (112). The arithmetic mean of each voiceprint is stored as the pattern voiceprint of a user and associated with a primary key of the said user, although other summary metrics for the voiceprint may also be used to construct the voiceprint.

Still in FIG. 6, the stage of determining a pattern voiceprint for validation (120) is implemented when access is attempted by the user. Initially, when access is attempted, the user repeats a phrase randomly selected by the system, and then the audio sample of the user repeating the phrase is captured and processed by the machine learning engine, which generates a new voiceprint. If the user provided a primary key, the stored pattern voiceprint associated with the primary key provided is selected for validation. If the user has not provided a primary key, it will be necessary to identify to what previously registered user the new voiceprint belongs; to this end, the new voiceprint will be compared with the different stored pattern voiceprints so as to find the pattern voiceprint that is closest to the new voiceprint. Therefore, the closest pattern voiceprint will be used to identify the user.

Still in FIG. 6, the anti-fraud method (300) comprises the authentication stage, which may be implemented to help ensure that the audio sample captured at the time access is attempted is the voice of a live speaker, and not a pre-recorded voice. The authentication starts with the transcription of the audio captured of the user repeating a randomly selected phrase in the previous stage. The text obtained from the audio transcription is compared with the target phrase, i.e., the one the user was requested to repeat. If the comparison between the transcribed phrase and the target phrase is approved, the method goes to the next stage; otherwise, access is denied.

Still in FIG. 6, if the authentication is approved, the method goes to the validation stage, i.e., comparing the new voiceprint with the pattern voice print selected in the stage of determining the pattern voiceprint for validation (120), i.e., the pattern voiceprint associated with the provided primary key or the pattern voiceprint deemed the closest one to the new voiceprint. From the comparison, a validation grade is generated, which grade is the result of the distance measured between the new voiceprint and the pattern voiceprint. If such grade is within the approval parameters, access is granted; otherwise, access is denied.

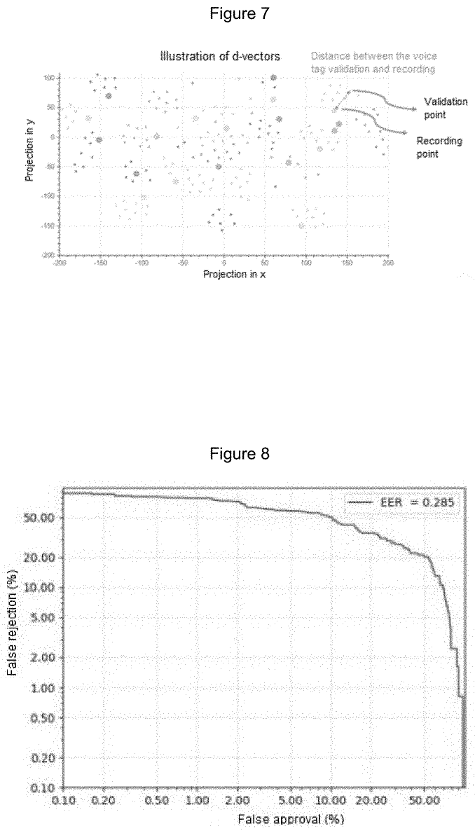

FIG. 7 shows an example of distance between the d-vector/voiceprint, wherein each dot represents a voiceprint, as well as an example of the distance calculated between a pattern voiceprint and a new voiceprint. In the example, the larger dots represent a pattern voiceprint that was registered previously, while the smaller dots of the same color represent the new voiceprint, obtained during an access attempt.

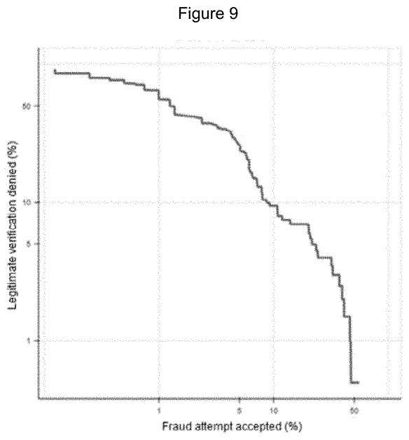

FIGS. 8 and 9 show an EER diagram obtained by applying SincNet's machine learning engine and the machine learning engine of the present disclosure, respectively. The EER obtained by the SincNet's machine learning engine was 0.285, while the EER obtained by the machine learning of the present disclosure was 0.100, which is evidence that the machine learning of the present disclosure obtains improved results compared to SincNet's.

The present disclosure includes a method for granting access (100) to a restricted area, preferably a call center or smartphone application, by means of voice biometrics applied to identify/validate a voiceprint (5). The present disclosure also presents a method for training (200) a machine learning engine (4) for determining a voiceprint (5) (d-vector) and an anti-fraud method (300) for authenticating a user (6).

Voiceprint (5) or d-vector is a numerical vector with 2.048 values which, in the present disclosure, is obtained by adapting the machine learning engine presented by SincNet, as will be discussed hereinafter. Such voiceprint represents the voice biometrics of a person and is capable of identifying them, such as occurs with a fingerprint. The vector is registered as the pattern voiceprint (5) of a user (6) and is stored in a storage device (3) associated with a primary key, and then it is compared with a new voiceprint (5) when access is attempted.

In the present disclosure, the terms “validation” and “verification” are used in relation to a voiceprint which is compared with a previously obtained tag; the voiceprint is validated when the voiceprint is deemed to be from a same user as the sample tag. The term “identification” in relation to a voiceprint (5) relates to finding a pattern voiceprint (5) in a storage device (3) from a user (6) to whom such voiceprint (5) pertains. The term “authentication” relates to the confirmation that the user to whom the voiceprint (5) pertains is the user who is attempting access to a restricted area.

Some embodiments of the present disclosure use an arrangement of physical and virtual electronic devices intended to verify or identify the identity of a user (6) through their voiceprint (5), configuring a system the devices of which can be generally defined as follows:
Input Device (1): Smartphone or computer application, sound recording apparatus, call to a call center. The device captures sound from the voice of the user (6) and puts it in digital format. FIG. 1 shows an example of use of the input device (1) being used to capture an audio sample of a user (6).
Processing Device (2): Computerized system, e.g., a cloud-based system. The device processes the machine learning engine (4), which generates and compares voiceprints (5), make the transcription from an audio sample, by converting this audio sample to text and based on this text do a comparison between the text transcribed and the target text and approves/rejects the authentication. FIG. 3 shows an example of processing of the processing device (2) generating voiceprints (5) of users (6).
Storage Device (3): Digital cloud-based storage systems and physical hard disks. The device stores previously registered voiceprints (5) for comparison against new voiceprints (5) through the processing device (2). In FIG. 4, one can observe a form of using the storage device (3) being used by the processing device (2).

The present disclosure also describes a system capable of implementing the stages of the indicated methods. An embodiment can be observed in FIG. 4, wherein the system comprises an input device (1) that communicates with the processing device (2), the processing device being configured to implement the stages of the method for granting access (100) to a restricted area, and alternatively being configured to implement the stages of the training method (200) and the anti-fraud method (300). The processing device (2) is also configured to communicate with the storage device (3) and generate responses to a system operator.

Some embodiments of the present disclosure use a neural network based on the SincNet network, as described in the article titled “Speaker Recognition from Raw Waveform with SincNet”, by Mirco Ravanelli and Yoshua Bengio, published in Spoken Language Technology Workshop (SLT), IEEE 2018. SincNet is a convolutional neural network (CNN) architecture that encourages the first convolutional layer to discover more meaningful filters for the network learning process. When convolutional neural networks (CNNs) are used in audio applications, the audio sample is typically pre-processed in the time domain, so that it be represented in the frequency domain through spectrograms, Mel-frequency cepstral coefficients (MFCCs), etc. It will be appreciated that other types of machine learning engines, and other representations of the speech waveform, may also be employed.

Some solutions demonstrate that pre-processing is capable of refining the audio sample feeding the network using only information relevant to the training. SincNet's proposal is different because it uses the audio sample with no pre-processing in the time domain, allowing the network to work with a signal with a much larger dimensionality than a processed signal. Accordingly, the first convolutional layer of the network has the role of working with this larger volume of information and determining which filters should be applied to the audio sample. The audio sample with raw signal, together with the preset sync functions, causes a convolution in the first layer of the network, which learns the only two parameters, i.e., upper and lower cutoff frequencies, to be defined in the first layer of the network. After the filtering procedure with sync functions, a regular CNN methodology is implemented using layers of pooling, normalization, activation, and dropout.

The method for granting access (100) to a restricted area of the present disclosure uses the architecture presented by SincNet with adaptations to achieve better results, when applied for identifying/verifying and authenticating a user (6) in a call center with an anti-fraud system.

The main stages of an example method for granting access (100) to a restricted area presented herein are as follows:

1. Training the machine learning engine (4);

2. Capturing the register audio sample;

3. Processing the machine learning engine;

4. Generating the register pattern voiceprint (5);

5. Capturing the identification or verification audio sample;

6. Processing the machine learning engine (4);

7. Generating the new voiceprint (5);

8. Comparing the new voiceprint (5) and the pattern voiceprint (5);

9. Identifying the closest pattern voiceprint;

10. Transcribing the audio sample;

11. Comparing the transcribed phrase against the actual phrase;

12. Approving/Rejecting the phrase;

13. Comparing the pattern voiceprints (5) and the validation attempt;

14. Scoring the validation;

15. Approving/Rejecting the validation attempt.

These stages are not necessarily carried out in sequence, and the number inserted next to them is for reference purposes.

For the purpose of better understanding the implementation of the illustrated method, the stages can be divided into groups as follows:
Stages 2, 3, and 4 are part of the voiceprint registering process;
Stages 5, 6, 7, 8, and 9 are part of the identification and/or verification process;
Stages 10, 11, and 12 are part of the authentication or anti-fraud process; and
Stages 13, 14, and 15 are part of the validation process.

Therefore, stage 1 includes the training of the machine learning engine (4) through the computerized processing device (2).

In stage 2, audio samples with voices of users (6) are captured through any of the input devices (1): smartphone application, sound recording apparatus or call to a call center.

In stage 3, the captured audio samples are processed through the computerized processing device (2).

In stage 4, the pattern voiceprints (5) are generated in the same processing device (2). Subsequently, the pattern voiceprints (5) are stored in one or more storage devices (3), such as cloud or hard disk.

In stage 5, a new audio sample is captured through any of the input devices (1).

In stage 6, the machine learning engine (4) is processed in the processing device (2).

In stage 7, the new voiceprint (5) is generated.

If the user (6) does not enter a primary key in stage 5, the process goes to stage 8, otherwise, it goes to stage 10.

In stage 8, the new captured voiceprint (5) is compared against a subgroup of pattern voiceprints (5) that was previously registered and saved in the storage device (3). This comparison takes place in the processing device (2).

In stage 9, the system returns the pattern voiceprint (5) that is the closest to the newly captured voiceprint (5). The process follows to stages 10, 11 and 12.

In stage 13, the new voiceprint (5) is compared against the closest pattern voiceprint (5) found in the processing device (2), and then the process follows to stages 14 and 15.

If the user (6) enters a primary key in stage 5, the process goes to stage 10. Stage 10 will also be implemented in case stage 9 has been implemented.

In stage 10, the audio sample is transcribed, e.g., by determining text phrases spoken by a user, in the processing device (2).

In stage 11, the text from the transcription of stage 10 is compared against the actual phrase targeted in the process.

In stage 12, the audio sample is authenticated or not based on the similarity between the targeted text and the one generated text from the transcription of stage 10, if the audio sample is authenticated the method goes to the next stage, if the audio sample is not authenticated the access is denied.

In stage 13, the captured voiceprint (5) is compared against the pattern voiceprint (5).

In stage 14, the comparison is scored in the processing device (2).

In stage 15, the validation attempt is approved or rejected.

Further details of the example for granting access (100) to a restricted area, the method for training (200) a machine learning engine (4) for determining a voiceprint (5) and the anti-fraud method (300) for authenticating a user (6) are provided below. The method for granting access (100) to a restricted area may incorporate the training method (200), as well as the anti-fraud method (300) or other similar methods.

The method for training (200) a machine learning engine (4) for determining a voiceprint (5) starts with the audio capture for at least 10 users (6) from an input device (1) for subsequent digitalization, as one can see from FIG. 1.

After the audio sample capture and digitalization, the audio file of each user (6) is divided into two parts, the first part comprising, a first portion of the audio length, e.g., about ⅔ of the audio length, and the second p comprising about ⅓ of the audio length. The first part of the captured audio samples are processed in the machine learning engine (4) through a processing device (2), i.e., for the neural network to determine the best applicable parameters for the resulting voiceprint (5) or d-vector to be distinctive between each of a voiceprints (5) from an audio sample from another person. After the training, validation is performed, with the second part comprising nearly ⅓ of the length for each user (6). FIG. 2 shows, schematically, the training and validation of the machine learning engine (4) being used in a processing device (2).

The stage where the machine learning engine (4) is trained is called in the state of art universal background model. Such machine learning engine (4) includes voice data from a number of different speakers or users (6) so that it may compare the test user (6) based on features present in many voices.

To adapt to a language, the use of fixed phrases from a same language causes the neural network to specialize in that specific language. Therefore, using the methodology of multiple, e.g., three, repetitions by phrase will improve the network ability in the language, thus producing better results. A training method (200) was developed where each user (6) is registered repeating, e.g., three fixed phrases three times, each phrase having a length, e.g., around three seconds. It will be appreciated that the number of phrases, repetitions, and phrase length may be varied. During researches for the development of the present disclosure, it was found that the results are significantly improved with such training methodology. However, the use of the same three phrases by all users (6) allows for an improved standardization, which also results in improved results.

The test stage is optional, but also preferable. The test is made with a set of voices from people other than those used in the training and validation, also separated into segments e.g., the three second segments described above. Next, the machine learning engine (4) represents the voice of a user (6) in a d-vector or voiceprint (5). The test is made by completing all stages of the method for granting access (100) to a restricted area, in order to verify the performance of the machine learning engine (4) being implemented by the processing device (2), together with the other stages of the method for granting access (100).

As described in the present disclosure, the application of the method for training (200) a machine learning engine (4) allowed for significantly improved results compared to those obtained by applying only the SincNet model. FIGS. 8 and 9 show the results when the SincNet model was applied and the machine learning engine (4) obtained from the training method (200), respectively. The EER (Equal Error Rate) obtained by the SincNet model was 0.285, while the EER obtained by the machine learning engine (4) obtained from the training method (200) was 0.100. This improved result was obtained due to adjustments that allowed the machine learning engine (4) to specialize in a specific language.

Once the training of the machine learning engine (4) is completed, such as, for example, through the training method (200) of the present disclosure, the machine learning engine (4) will be capable of creating a d-vector or voiceprint (5) for each new user (6) from an audio sample of their voice. The trained machine learning engine (4) is stored to be processed by a processing device (2) after serialization in the pickle module of Python, as a pkl format file.

Once the training of the machine learning engine (4) is completed, the machine learning engine (4) will be ready to be applied in production. Therefore, one will be able to implement the next stages of the method for granting access (100) to a restricted area several times without the need of training the machine learning engine (4) again. A new training of the machine learning engine (4) is required only when a performance out of the parameters established as acceptable is identified, such as an EER above the percentage allowed.

The pattern voiceprint (5) registering process starts with the stage where the audio sample is captured for registering, such stage being implemented through the input devices (1), where user voice samples are captured by means of a call to a call center, an audio recording device file, a smartphone application, etc. and converted into digitalized audio samples in way, mp3, wma, aac, ogg format or another format, as shown schematically in FIG. 1. The audio sample must be captured so as to allow one to obtain an audio sample with little noise and little interference. One approach to capturing audio samples for registering is to carry them out at a bank branch, since there is a higher control of capturing conditions at these sites. Preferably, the recording of the audio sample is performed multiple times, e.g., with the user repeating a same phrase three times.

The pattern voiceprint (5) of a user (6), as one can see from the example in FIG. 5, is calculated as follows: given a user (6) L and i1, i2 and i3, these three repetitions being part of a same phrase recorded. The voiceprint (5) of each repetition, e.g., the d-vector, is obtained from the second-to-last layer of the network, once all filtering calculations are made, as presented in FIG. 5. Each of repetitions i1, i2, and i3 generates a different voiceprint. The arithmetic mean of the three voiceprints of a same user (6) is calculated by generating the pattern voiceprint (5) of a user (6), which is stored in a storage device (3) and used for future comparisons. When a same phrase is repeated three times by a same user (6), the variation of their voiceprint is lower, making it purer for future comparisons, thus reducing the risk of frauds.

In order to preserve the voice features and obtain an improved performance, no pre-processing of the audio sample is performed. Keeping the audio features as they were originally captured, with no pre-processing, is important so that no relevant information is lost when determining the pattern voiceprint (5) of a user (6). Therefore, the machine learning engine (4) will define if filters should be applied to the captured audio sample.

The patter voiceprint (5) of the user (6)—or the d-vector—is stored in a storage device (3), in a Python data structure, where the pattern voiceprint (5) of a user (6) can be retrieved for comparison against other voiceprint (5). The generated pattern voiceprint (5) may be used to identify a user (6) and may be used for direct comparison or verification, e.g., a comparison between a new voiceprints (5) with a pattern voice print (5) for verification of similarity. The pattern voiceprint (5) also may be used to identify, e.g., locate the user (6) to whom a certain new voiceprint (5) pertains, such identification taking place when comparison is made against the pattern voiceprint (5) deemed the closest one with a new voiceprint (5).

The pattern voiceprint (5) registering process which comprises the stages of capturing the register audio sample, processing the machine learning engine (4), and generating the register pattern voiceprint (5), is implemented for each user (6) whose pattern voiceprint (5) is inserted in the database, such stages being implemented according to a new user's (6) request for registering, not interfering with the previous and next stages.

In the method for granting access (100) to a restricted area, when a user (6) has to be identified or verified, the identification or verification process takes place. In other words, when a user requests access to a restricted area, such as, for example, in a call center, the identification or verification process takes place, starting from the stage where the identification or verification audio sample is captured through an input device (1), such capture usually occurring through a call to a call center, where a user requests a specific service, such as information on their bank account, for example.

The audio file to be identified or verified is processed by the machine learning engine (4) through the processing device (2) to obtain the d-vector or voiceprint (5) of the user (6), with 2,048 numerical values. Such voiceprint (5) is generated similarly to what occurs in the patter voiceprint (5) registering process, but in this stage, preferably, only one phrase is repeated, and the goal is to compare this new voiceprint (5) with a pattern voiceprint (5) already registered and stored in the storage device (3).

In case the user (6) enters a primary identification key, which can be their identity document, branch/account number, phone number or another form of identification, the method for granting access (100) to a restricted area implements the audio transcription stage.

If the user (6) enters no primary identification key, the voiceprint (5) has to be identified; therefore, such voiceprint (5) will be compared against a subgroup of pattern voiceprints (5) of registered users (6) until the closest pattern voiceprint (5) is found. Such subgroups are sets of pattern voiceprints (5) that are similar to one another and are used to facilitate the search for the pattern voiceprint (5) in the universe of registered pattern voiceprints (5) stored. After determining the closest pattern voiceprint (5), the method for granting access (100) to a restricted area goes to the next stage, where the audio sample is transcribed.

The authentication process is optional, but preferable. Such authentication process is intended to validate a phrase in order to prevent the use of real voices recorded by users (6) for bypassing the method for granting access (100) to a restricted area, such as, for example, someone with access to the voice of a user (6) wishing to validate it and, after capturing the voice of the user (6) without authorization, tries to use it later to obtain access to a bank transaction, or a recorded user (6) themselves providing a sample of their voice for another person to attempt access on their behalf.

The preferred authentication process is the anti-fraud method (300) for authenticating a user (6), such anti-fraud method (300) carrying out the transcription of the audio sample of the user (6) using a second machine learning engine based on deep neural networks or other manner of determine text phrases spoken by a user. The transcribed phrase is usually a phrase requested to the user by the system by means of the call center agent, such as a phrase randomly selected from a group of phrases, previously defined or not, for the user to repeat. The phrase repeated by the user (6) is transcribed by the second machine learning engine.

Once the audio sample is transcribed, the anti-fraud method (300) compares the transcribed phrase against the actual phrase or the targeted phrase. If the requested and the transcribed phrases are similar, the method (300) implements the phrase approval stage, e.g., where the user (6) is authenticated, otherwise, the phrase rejection stage is implemented, and then the anti-fraud method (300) for authenticating a user (6) is completed. The similarity between the transcribed and requested phrases is measured through mathematical distance metrics, such distance being previously defined.

When authentication is denied in the authentication process, an authentication rejection action protocol can be initiated. Such protocol can include actions such as new authentication attempt, end of attempted access, start of an alternative validation method, inclusion of the voiceprint (5) of the user attempting access in a list of potential scammers, etc.

After the optional authentication or anti-fraud process, the validation process takes place, including the stages of comparing the pattern voiceprint (5) from a user (6) previously registered and the new voiceprint (5) from the validation attempt, scoring the validation and approving or rejecting the validation attempt. The pattern voiceprints (5) and the new voice print (5) from the validation attempt are compared, such comparison being made by calculating the distance between the voiceprints.

To calculate the distance between the voiceprints (5), the “T-Normalization” concept may be employed, as described by Roland Auckenthaler et al. in the article titled “Score Normalization for Text-Independent Speaker Verification System”, and is adapted to implement SincNet as the model for voiceprints, instead of classical Gaussian mixture models. The expression applied to calculate the distance between voiceprints can be seen in equation 1:

$${S}_{{T}_{norm}} = \frac{D ( {O}_{t} , {λ}_{t} ) - {μ}_{t}}{{σ}_{t}} \\ T - Normalization \qquad Equation 1$$

In the equation above, D(Oₜ,λₜ) is the cosine distance between new voiceprint (5) Oₜ of the speaker to be tested and their registered pattern voiceprint (5) λₜ. And both μₜ and σₜ are the standard deviation average for the distances of Oₜ, considering a subset of voiceprints of impostors. Using the T-Normalization caused improved results, especially because of the effect on the variation of channel between service types and devices used for capturing audio samples, as the distance is normalized by the difference between test speech and impostor speech, and not by a previously defined distance threshold.

Once the pattern voiceprint (5) and the new voiceprint (5) are compared through the calculation of distance, the validation scoring stage is implemented, in which a score of similarity between the pattern and the new voiceprints (5) is attributed, for example, “zero” being a score for two fully distinct voiceprints and “one thousand” being a score for two fully identical voiceprints (5). FIG. 7 shows an example of the calculation of the distance between voiceprints and of the validation.

After the validation is scored, the authentication approval/rejection stage is implemented, and this ends the validation process and the method for granting access (300) to a restricted area. The validation process can be performed whether before or after the authentication process.

For the method for granting access (100) to a restricted area to be implemented in a call center environment with audio capture at reduced bandwidth, e.g., 8 kHz, or an application where the user's and agent's channels are stored in the same file, a neural network is used for separation of the speakers, such network being capable of separating voice parts related to the speech for each, the user's (6) and the agent's channel. Therefore, the voices of each individual in a conversation between a call center agent and the user (6) are separated without the need of two distinct channels, allowing for the method to be applied in single-channel telephone systems.

As described above, the stages of the method for granting access (100) to a restricted area are not necessarily carried out in sequence. Therefore, after the training of the machine learning engine, the registering process is performed whenever a user's voiceprint has to be inserted in the database. Likewise, at each identification or validation request, the identification and/or verification process and the validation process are performed, and there may be an anti-fraud layer.

The method for training (200) a machine learning engine (4) and the anti-fraud method (300) for authenticating a user can be applied to the method for granting access (100) in an integral or partial manner, or other similar methods may be used.

Embodiments of the present disclosure may: (i) allow verification of someone's identity in calls to call centers, even when there is only one communication channel available, which causes a reduced audio quality; (ii) allow identification of a user through their voiceprint, even when no other form of identification is provided; (iii) implement an anti-fraud process that uses a transcription approach based on deep neural networks; (iv) adapts to the Portuguese or other languages, with its different phonetical nuances; (v) implement normalization methodologies adapted to improve performance in different audio channels; (vi) allows for multiple applications, both for identifying a user from a group and for verifying the authenticity of a user; (vii) allow for the inclusion of other available anti-fraud layers, such as geolocation, for validating an authentication attempt; (viii) reduce the service time, as there will be no or a reduced need for collecting personal information; (ix) speed up the validation process, thus improving customer satisfaction.

It is to be understood that the present description is not limited in its application to the details set forth herein and that the invention is capable of other embodiments and of being practiced or carried out in various ways, within the scope of the appended claims. Although specific terms have been used herein, they are used in a generic, descriptive sense only and not for purposes of limitation.

1. A method for granting access to a restricted area, comprising:
training a machine learning engine, wherein the machine learning engine to generate voiceprints of users from captured audio samples;
recording audio samples of the user voice;
generating a pattern voiceprint for the user based on the audio samples of the user voice using the machine learning engine and associating the pattern voiceprint with a primary key of such user;
responsive to a request to identify the user to allow access, receive a second audio sample from the user and generating a new voiceprint based on the second audio sample;
verifying the new voiceprint through a comparison between the new voiceprint and the pattern voiceprint; and
responsive to successfully validating the new voiceprint, permitting access to the user.

2. The method of claim 1, further comprising:
authenticating the user by
requesting the user to repeat a phrase,
transcribing the phrase repeated by the user from the second voice sample, and
comparing the transcribed phase against a targeted phrase.

3. The method of claim 2, further comprising:
randomly selecting the phrase repeated by the user.

4. The method of claim 1, wherein the training machine learning engine further comprises:
capturing audio samples from a plurality of users;
receiving audio samples from each of the plurality of users repeating a fixed phrase multiple times;
dividing the audio samples from each of the plurality of users into two audio parts;
training the machine learning engine using a first part of the audio samples for the plurality of users;
validating the machine learning engine using the second audio part of the audio samples for each of the plurality of users.

5. The method of claim 4, wherein the audio samples received from each of the plurality of users include three repetitions of a same phrase, the method further comprising:
registering a voiceprint based on the arithmetic mean of voiceprints generated for each one of the three repetitions of the same phrase.

6. The method of claim 1, wherein the pattern voiceprints are stored in subgroups comprising the closest pattern voiceprints.

7. The method of claim 1, wherein the request for access is for a specific service of a call center environment or an application.

8. The method of claim 1, further comprising:
using a neural network to separate the user's audio sample from a call center agent's audio sample.

9. A method for training a machine learning engine, comprising:
capturing audio samples from a plurality of different people through at least one audio capture device, wherein each of the plurality of people repeats at least a same fixed phrase at least three times;
dividing each audio sample of each of the plurality of different people into at least two audio parts;
training the machine learning engine by using the first part of the audio samples captured from a plurality of people; and
validating the trained machine learning engine by using the second part of the audio samples from the plurality of people.

10. The method of claim 9, wherein the audio sample for the fixed phrase is at least 3 seconds.

11. The method of claim 9, wherein audio samples are captured for each of the people for the repetition of at least three different phrases.

12. A method for authenticating a user attempting access to access a restricted area, comprising:
requesting the user to repeat a randomly chosen phrase;
using a neural network to separate audio samples of an agent from audio samples of the user who is requesting access in a single channel telephone system for a call center;
capturing the audio sample of the phrase repeated by the user;
transcribing the phrase repeated by the user; and
comparing the transcribed phrase with a targeted phrase to authenticate the user.

13. A system for granting access to a restricted area, comprising:
at least one input device configured to capture an audio sample of a user;
at least one processing device configured to:
receive captured audio samples for a plurality of users,
train a machine learning engine, the machine learning engine configured to generate a voice print for the plurality of users from the respective captured audio samples for such users,
register the pattern voiceprint of each of the plurality of users for a pattern voiceprint of each user in association with a primary key of the user,
responsive to a user attempting access, generate a new voiceprint for the user,
determine the pattern voiceprint of the user to be validated when access is attempted, wherein conditioned on a primary key for the user being available, the pattern voiceprint of the user is determined based on the primary key,
validate the new voiceprint through a comparison between the new voiceprint for the user attempting access and the pattern voiceprint;
at least one storage device accessible to the processing device to store the generated pattern voiceprints.

14. The system of claim 15, wherein the processing device is further configured to authenticate a user by requesting the user to repeat a phrase, transcribing the phrase, and comparing the transcribed phrase against a targeted phrase.

15. The system of claim 16, wherein the processing device if further configured to randomly select the phrase.

16. The system of claim 16, wherein the system is further configured to train a machine learning engine by receiving captured audio samples from a plurality of users repeating a fixed phrase multiple times, dividing the audio samples into parts, training the machine learning engine using a first part of the audio samples from each user, and validating the machine learning engine using a second part of the audio samples from each user.

17. The system of claim 17 wherein the audio samples for recording comprise three repetitions of a same phrase, and the pattern voiceprint is the arithmetic mean of the three voiceprints generated for each one of the repetitions.

18. The system of claim 17, wherein the pattern voiceprints are stored in subgroups comprising the closest pattern voiceprints.

19. The system of claim 17, wherein the system is further configured to use a neural network for separation of the user's and agent's audio samples as part of authenticating a user's request for access to a call center.
